(19) United States
(12) Patent Application Publication
(10) Pub. No.: US 2021/0039445 A1
(43) Pub. Date: Feb. 11, 2021

(54) PNEUMATIC TIRE

(71) Applicant: Toyo Tire Corporation, Itami-shi (JP)

(72) Inventor: Yoshiki Sato, Itami-shi (JP)

(73) Assignee: Toyo Tire Corporation, Itami-shi (JP)

(21) Appl. No.: 16/936,800

(22) Filed: Jul. 23, 2020

(30) Foreign Application Priority Data
Aug. 7, 2019 (JP) 2019-145292

(51) Int. Cl. B60C 11/11; B60C 11/12

(52) U.S. Cl. CPC B60C 11/11; B60C 11/1236; B60C 11/1204

(57) ABSTRACT

A pneumatic tire comprises at least one block partitioned by a groove and having a plurality of corners, the plurality of corners includes a largest corner at which angle is greatest thereamong and is greater than 180°, and the at least one block comprises a first block groove which is arranged at the largest corner.

### CROSS REFERENCE TO RELATED APPLICATIONS

This application claims the benefit of priority of Japanese application no. 2019-145292, filed on Aug. 7, 2019, which is incorporated herein by reference.

### BACKGROUND OF THE INVENTION

### Field of the Invention

The present disclosure relates to a pneumatic tire.

### Description of the Related Art

Conventionally a pneumatic tire might, for example, comprise a plurality of blocks partitioned by groove(s) (e.g., JP2016-68628A). In addition, each of the blocks has a plurality of corners, the plurality of corners being such that the larger the angle at the corner the greater the rigidity of the corner. Accordingly, because of the variation that exists in rigidity of corners, there will be occurrence of variation in rigidity at blocks.

The problem is therefore to provide a pneumatic tire that will make it possible to suppress occurrence of variation in rigidity at blocks.

### SUMMARY OF THE INVENTION

There is provided a pneumatic tire comprises:

at least one block partitioned by a groove and having a plurality of corners;

wherein the plurality of corners includes a largest corner at which angle is greatest thereamong and is greater than 180°; and

wherein the at least one block comprises a first block groove which is arranged at the largest corner.

Further, the pneumatic tire may have a configuration in which:

wherein the at least one block comprises first and second peripheral edges that make up the largest corner;

the first block groove comprises first and second groove edges; and

the first groove edge is formed in such fashion as to form a straight line together with the first peripheral edge.

Further, the pneumatic tire may have a configuration in which:

wherein length of the first peripheral edge is less than length of the second peripheral edge.

Further, the pneumatic tire may have a configuration in which:

wherein the at least one block comprises first and second peripheral edges that make up the largest corner;

the first peripheral edge extends in a tire width direction in such fashion that angle of inclination thereof with respect to the tire width direction is less than 45°; and

the second peripheral edge extends in a tire circumferential direction in such fashion that angle of inclination thereof with respect to the tire circumferential direction is less than 45°.

Further, the pneumatic tire may have a configuration in which:

wherein depth of the first block groove decreases as one proceeds toward the interior of the at least one block from a peripheral edge of the at least one block.

Further, the pneumatic tire may have a configuration in which:

wherein the at least one block comprises a plurality of peripheral edges including the first and second peripheral edges; and

length of the first peripheral edge is shortest among the plurality of peripheral edges.

Further, the pneumatic tire may have a configuration in which:

wherein the at least one block comprises at least one sipe; and

a first end of the at least one sipe is contiguous with the groove, and a second end of the at least one sipe is located at the interior of the at least one block.

Further, the pneumatic tire may have a configuration in which:

wherein width of the first block groove decreases as one proceeds toward the interior of the at least one block from a peripheral edge of the at least one block.

Further, the pneumatic tire may have a configuration in which:

wherein length of the first groove edge is less than length of the first peripheral edge.

Further, the pneumatic tire may have a configuration in which:

wherein length of the first groove edge is less than length of the second groove edge.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing the principal components at the tread surface of a pneumatic tire associated with same embodiment as they would exist if unwrapped so as to lie in a single plane;

FIG. 3 is an enlarged view of region III in FIG. 2;

FIG. 4 is an enlarged view of a section taken along IV-IV in FIG. 3; and

FIG. 5 is a drawing showing the principal components at the tread surface of a pneumatic tire associated with another embodiment as they would exist if unwrapped so as to lie in a single plane.

### DETAILED DESCRIPTION OF THE INVENTION

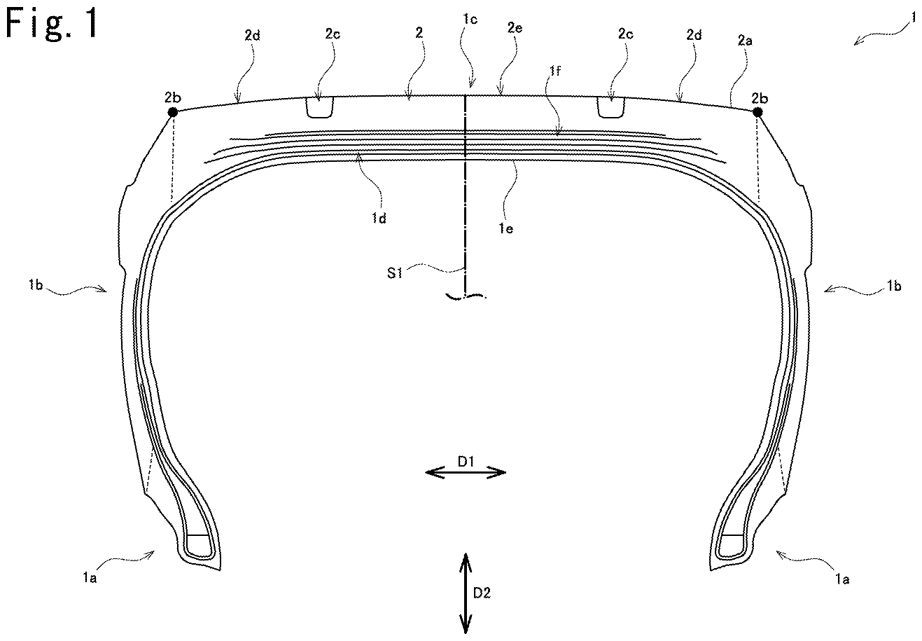

Below, an embodiment of a pneumatic tire is described with reference to FIG. 1 through FIG. 4. At the respective drawings (and the same is true for FIG. 5), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator is the curve formed by the intersection of tire equatorial plane S1 and the outer surface (tread surface 2a, described below) in the tire radial direction D2 of tire 1.

In the tire width direction D1, the side toward the interior is the side which is nearer to tire equatorial plane S1, and the side toward the exterior is the side which is farther from tire equatorial plane S1. Furthermore, in the tire radial direction D2, the side toward the interior is the side which is nearer to the tire rotational axis, and the side toward the exterior is the side which is farther from the tire rotational axis.

As shown in FIG. 1, tire 1 associated with the present embodiment is provided with a pair of bead regions 1a at which beads are present; sidewall regions 1b which extend outwardly in the tire radial direction D2 from the respective bead regions 1a; and tread region 1c, the exterior surface in the tire radial direction D2 of which contacts the road surface and which is contiguous with the outer ends in the tire radial direction D2 of the pair of sidewall regions 1b. In accordance with the present embodiment, tire 1 is a pneumatic tire 1, the interior of which is capable of being filled with air, and which is capable of being mounted on a rim (not shown).

Furthermore, tire 1 is provided with carcass layer 1d which spans the pair of beads, and innerliner layer 1e which is arranged at a location toward the interior from carcass layer 1d and which has superior functionality in terms of its ability to impede passage of gas therethrough so as to permit air pressure to be maintained. Carcass layer 1d and innerliner layer 1e are arranged in parallel fashion with respect to the inner circumferential surface of the tire over a portion thereof that encompasses bead regions 1a, sidewall regions 1b, and tread region 1c.

Tread region 1c is provided with tread rubber 2 having tread surface 2a which contacts the road surface, and belt layer 1f which is arranged between tread rubber 2 and carcass layer 1d. Present at tread surface 2a is the contact patch that actually comes in contact with the road surface, and the portions within said contact patch that are present at the outer ends in the tire width direction D1 are referred to as contact patch ends 2b, 2b.

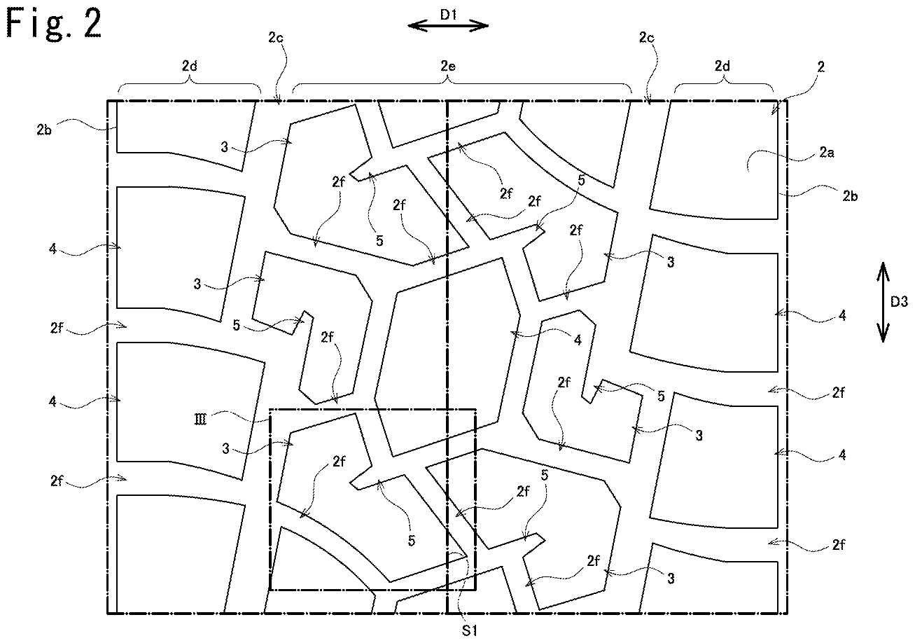

As shown in FIG. 1 and FIG. 2, tread rubber 2 comprises a plurality of main grooves 2c, 2c that extend in the tire circumferential direction D3. Main groove 2c extends continuously along the entire length of tire circumferential direction D3. In addition, the constitution is such that main groove 2c extends in zigzag fashion along the tire circumferential direction D3. Note that a constitution may also be adopted in which main groove 2c extends in parallel fashion with respect to the tire circumferential direction D3.

There is no limitation with respect thereto, it also being possible, for example, to adopt a constitution in which main groove 2c comprises so-called tread wear indicator(s) (not shown) which are portions at which depth of the groove is reduced so as to make it possible to ascertain the extent to which wear has occurred as a result of the exposure thereof that takes place in accompaniment to wear. Furthermore, while there is no particular limitation with respect to the number of main grooves 2c, the number of main grooves 2c that are present in the present embodiment is two.

Furthermore, while there is no particular limitation with respect thereto, it is also possible to adopt a constitution in which, for example, main grooves 2c are each of groove width not less than 3% of the distance (dimension in the tire width direction D1) between contact patch ends 2b, 2b. Furthermore, while there is no particular limitation with respect thereto, it is also possible to adopt a constitution in which, for example, main grooves 2c are each of groove width not less than 5 mm.

Tread rubber 2 comprises a plurality of land portions 2d, 2e that are partitioned by main groove (s) 2c, 2c and contact patch end(s) 2b, 2b. At the plurality of land portions 2d, 2e, land portion(s) 2d which are partitioned by main groove(s) 2c and contact patch end(s) 2b and which are arranged in outwardmost fashion in the tire width direction D1 are referred to as shoulder land portion(s) 2d, and land portion(s) 2e which are partitioned by the main grooves 2c, 2c that are respectively adjacent thereto and which are arranged between pair of shoulder land portions 2d, 2d are referred to as middle land portion(s) 2e.

Among middle land portion(s) 2e, note that those land portion(s) 2e which intersect tire equatorial plane S1 are referred to as center land portion(s) 2e. That is, the pair of main grooves 2c, 2c that partition center land portion(s) 2e are arranged so as to respectively be separated from tire equatorial plane S1 in the tire width direction D1. Furthermore, while there is no particular limitation with respect to the number of land portions 2d, 2e, because in the present embodiment the number of main grooves 2c that are present is two, the number of land portions 2d, 2e that are present is three, and the number of middle land portions 2e that are present is one.

As shown in FIG. 2, land portions 2d, 2e comprise a plurality of land grooves 2f extending in at least one of the tire width direction D1 and the tire circumferential direction D3. As a result, land portions 2d, 2e comprise a plurality of blocks 3, 4 that are partitioned by grooves 2c, 2f. In addition, the plurality of blocks 3, 4 are arrayed along the tire circumferential direction D3. While there is no particular limitation with respect thereto, note that it is also possible to adopt a constitution in which, for example, land grooves 2f have groove widths not less than 2 mm.

Middle land portion 2e comprises block(s) 4 partitioned by a plurality of land grooves 2f, and block(s) 3, 4 partitioned by main groove(s) 2c and a plurality of land grooves 2f. Shoulder land portion 2d comprises block(s) 4 partitioned by main groove(s) 2c and a plurality of land grooves 2f.

Note that it is also possible to adopt a constitution in which land portions 2d, 2e do not comprise blocks 3, 4 but are of rib-like shape, being continuous in the tire circumferential direction D3. That is, it is sufficient that at least one of land portions 2d, 2e be of block-like shape such that block(s) 3, 4 are arrayed along the tire circumferential direction D3 as a result of subdivision in the tire circumferential direction D3 by land grooves 2f.

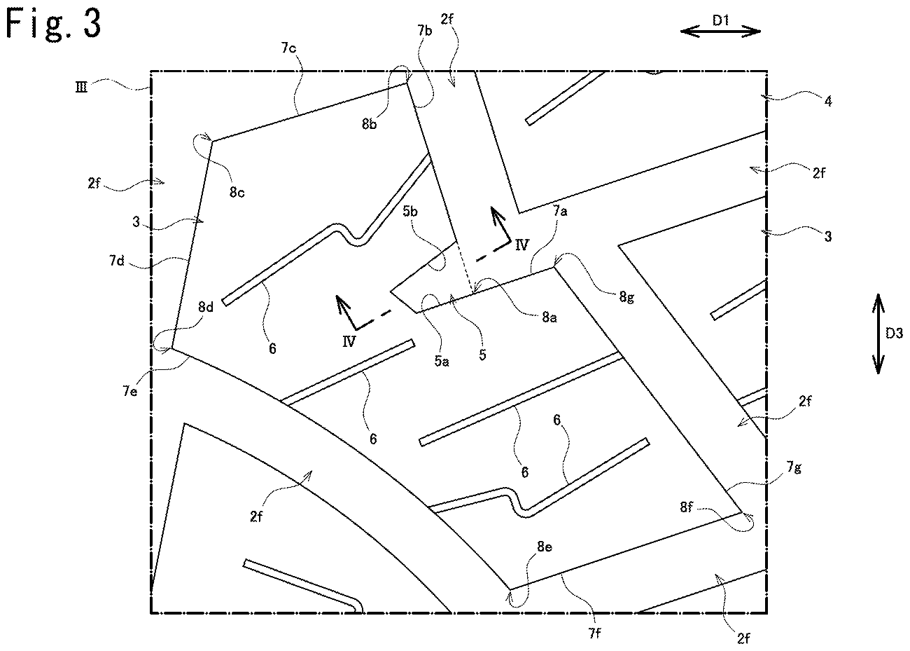

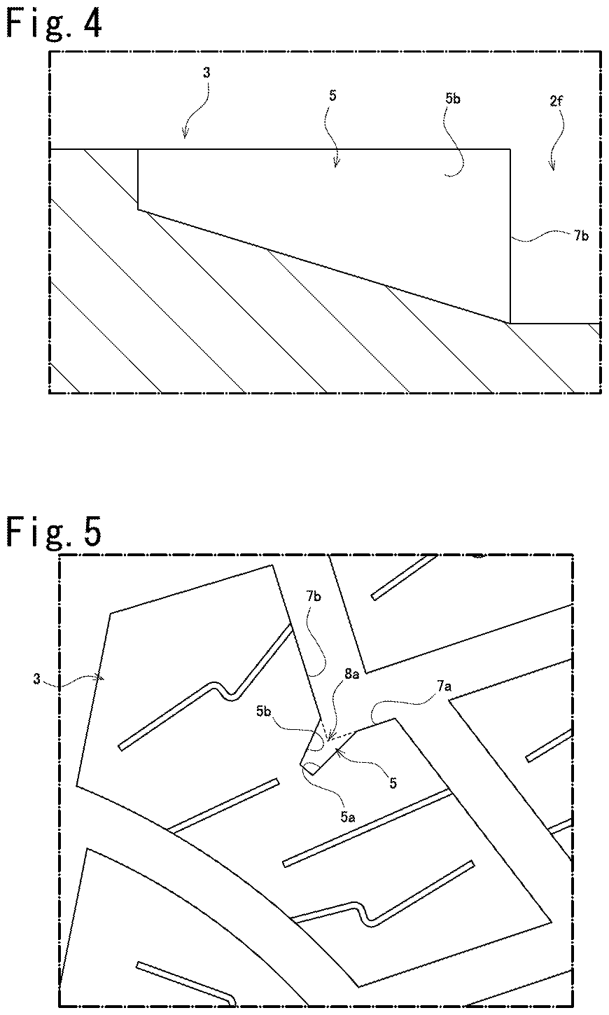

The constitution of block 3 having corner(s) 8a with angle(s) greater than 180° will now be described with reference to FIG. 3 and FIG. 4.

Hereinbelow, note that blocks 3 having corner(s) 8a with angle(s) greater than 180° are referred to as first blocks 3, other blocks 4 being referred to as second blocks 4. Furthermore, while a plurality of first blocks 3 of differing shape are present in the present embodiment, note that description is given below with respect to the constitution of one particular type of first block 3.

As shown in FIG. 3, first block 3 comprises block groove 5 and plurality of sipes 6. For example, among the recesses 5, 6 which are present at first block 3, recesses of width not less than 1.6 mm are referred to as block grooves 5, and recesses of width less than 1.6 mm are referred to as sipes 6.

One end of sipe 6 is contiguous with groove 2f, and the other end of sipe 6 is located at the interior of first block 3. That is, one end of sipe 6 is open, and the other end of sipe 6 is closed. Note that it is also possible to adopt a constitution in which the two ends of sipe 6 are open, being contiguous with groove(s) 2c, 2f, 5; and it is also possible to adopt a constitution in which the two ends of sipe 6 are closed, being located at the interior of first block 3. Furthermore, it is also possible to adopt a constitution in which first block 3 does not comprise sipe(s) 6.

First block 3 comprises a plurality of peripheral edges 7a through 7g, and a plurality of corners 8a through 8g. In addition, first block 3 is formed so as to be roughly polygonal in shape. While there is no particular limitation with respect to the shape of first block 3, first block 3 is formed so as to be roughly heptagonal in shape in the present embodiment.

At FIG. 3 (and the same is true of FIG. 5), imaginary line(s) which are extension(s) of peripheral edge(s) 7b contiguous with block groove(s) 5 are shown in broken line. Note that where block groove 5 is contiguous with peripheral edge 7b, the length of said peripheral edge 7b is taken to be the length inclusive of the imaginary line which is an extension of said peripheral edge 7b. Furthermore, where block groove 5 is located at an end of peripheral edge 7b, the angle at corner 8a made up of said peripheral edge 7b is taken to be the angle at corner 8a made up of the imaginary line which is an extension of said peripheral edge 7b.

It so happens that, at plurality of corners 8a through 8g, the larger the angle at corner 8a through 8g the greater the rigidity at corner 8a through 8g. That is, rigidity is greatest at largest corner 8a which has the greatest angle. Moreover, the angle at largest corner 8a is greater than 180°. Note that while there is no particular limitation with respect to the number of corners 8a with angles greater than 180°, first block 3 of the present embodiment is provided with one corner 8a at which the angle is greater than 180°.

In this regard, block groove 5 is arranged at largest corner 8a. More specifically, block groove 5 is contiguous with first peripheral edge 7a and second peripheral edge 7b which make up largest corner 8a. Even more specifically, first groove edge 5a of block groove 5 is contiguous with first peripheral edge 7a, and second groove edge 5b of block groove 5 is contiguous with second peripheral edge 7b. As a result, because it is possible to suppress occurrence of a situation in which rigidity of largest corner 8a becomes too large, this will make it possible to suppress occurrence of variation in rigidity at first block 3.

Accordingly, for example, because it will be possible to cause contact patch pressure to be made more uniform, it will be possible to improve stability in handling. While such benefit will be exhibited on all road surfaces, it will be exhibited in particularly marked fashion on snowy road surfaces (especially icy road surfaces). Furthermore, for example, it will be possible to suppress occurrence of uneven wear at first block 3. While such benefit will be exhibited on all road surfaces, it will be exhibited in particularly marked fashion on dry road surfaces.

Furthermore, first groove edge 5a of block groove 5 is formed so as to be continuous with first peripheral edge 7a making up largest corner 8a. More specifically, first groove edge 5a is formed so as to be continuous with first peripheral edge 7a which is the shorter of first and second peripheral edges 7a, 7b making up largest corner 8a. While there is no particular limitation with respect thereto, note in the present embodiment that first groove edge 5a is contiguous with first peripheral edge 7a, which is shortest among the plurality of peripheral edges 7a through 7g, in such fashion as to, together with first peripheral edge 7a, form a straight linear (or curved line) shape.

As a result, due to the fact that first peripheral edge 7a, which is short, is made to be continuous with first groove edge 5a, this causes edge component(s) formed by first peripheral edge 7a and first groove edge 5a to be long. Accordingly, because it is possible to adequately cause functionality of the corresponding edge component(s) to be made manifest, it is possible to improve tire performance on adverse road surfaces and snowy road surfaces.

Moreover, first peripheral edge 7a which makes up largest corner 8a extends in the tire width direction D1. More specifically, the angle of inclination of first peripheral edge 7a with respect to the tire width direction D1 is less than 45°. As a result, the functioning of edge component(s) at first peripheral edge 7a makes it possible to suppress sliding in the tire circumferential direction D3.

Moreover, second peripheral edge 7b which makes up largest corner 8a extends in the tire circumferential direction D3. More specifically, the angle of inclination of second peripheral edge 7b with respect to the tire circumferential direction D3 is less than 45°. As a result, the functioning of edge component(s) at second peripheral edge 7b makes it possible to suppress sliding in the tire width direction D1.

Thus, because first peripheral edge 7a and second peripheral edge 7b make up largest corner 8a at which adequate rigidity is ensured, it is possible to adequately cause functioning of edge components at respective first and second peripheral edges 7a, 7b. Moreover, because first peripheral edge 7a and second peripheral edge 7b extend in respectively different directions D1, D3, it will be possible to suppress sliding with respect to respective directions D1, D3.

On the other hand, if rigidity of largest corner 8a becomes too low, there are situations in which this could cause reduction in tire performance. For example, it may be the case that functionality of edge components attributable to first and second peripheral edges 7a, 7b making up largest corner 8a cannot adequately be made manifest. Furthermore, it may for example be the case that occurrence of variation in rigidity at first block 3 causes, for example, there to be nonuniformity in contact patch pressure, or causes occurrence of uneven wear at first block 3.

As shown in FIG. 4, depth of block groove 5 is therefore made to decrease as one proceeds toward the interior from the peripheral edge of block 3. As a result, occurrence of a situation in which rigidity at largest corner 8a becomes too low is suppressed. Note that it is also possible to adopt a constitution in which depth of block groove 5 decreases in intermittent fashion (the groove bottom is of staircase-like shape); in the present embodiment, the constitution is such that depth of block groove 5 decreases in continuous fashion (the groove bottom is of smooth shape).

Note that whereas reference was made to FIG. 3 and FIG. 4 and description was given with respect to the constitution of one particular type of first block 3, returning to FIG. 2, at pneumatic tire 1 associated with the present embodiment, the constitutions of first blocks 3 of different shape are also such that they comprise block groove(s) 5 arranged at largest corner(s) 8a. That is, the constitution of the present embodiment is such that all first blocks 3 comprise block grooves 5 arranged at largest corners 8a thereof.

As described above, the pneumatic tire 1 of the embodiment includes:

at least one block 3 partitioned by a groove 2c, 2f and having a plurality of corners 8a through 8g;

wherein the plurality of corners 8a through 8g includes a largest corner 8a at which angle is greatest thereamong and is greater than 180°; and

wherein the at least one block 3 comprises a first block groove 5 which is arranged at the largest corner 8a.

In accordance with such constitution, largest corner 8a is that which among the plurality of corners 8a through 8g has the largest angle; moreover, the angle at largest corner 8a is greater than 180°. In this regard, because block groove 5 is arranged at largest corner 8a, it is possible to suppress occurrence of a situation in which rigidity of largest corner 8a becomes too large. As a result, it is possible to suppress occurrence of variation in rigidity at block 3.

Further, in the pneumatic tire 1 of the embodiment,

wherein the at least one block 3 comprises first and second peripheral edges 7a, 7b that make up the largest corner 8a;

the first block groove 5 comprises first and second groove edges 5a, 5b; and

the first groove edge 5a is formed in such fashion as to form a straight line together with the first peripheral edge 7a.

In accordance with such constitution, because one of the groove edges 5a at block groove 5 is continuous with one 7a of the first and second peripheral edges 7a, 7b, edge component(s) formed by said peripheral edge 7a and groove edge 5a are made to increase in length. This makes it possible to improve functionality of said edge component(s).

Further, in the pneumatic tire 1 of the embodiment,

wherein length of the first peripheral edge 7a is less than length of the second peripheral edge 7b.

In accordance with such constitution, because one of the groove edges 5a at block groove 5 is continuous with the shorter 7a of the first and second peripheral edges 7a, 7b, edge component(s) of the shorter peripheral edge 7a are extended by edge component(s) of groove edge 5a. This makes it possible to adequately cause functionality of said edge component(s) to be made manifest.

Further, in the pneumatic tire 1 of the embodiment,

wherein the at least one block 3 comprises first and second peripheral edges 7a, 7b that make up the largest corner 8a;

the first peripheral edge 7a extends in a tire width direction D1 in such fashion that angle of inclination thereof with respect to the tire width direction D1 is less than 45°; and

the second peripheral edge 7b extends in a tire circumferential direction D3 in such fashion that angle of inclination thereof with respect to the tire circumferential direction D3 is less than 45°.

In accordance with such constitution, because first peripheral edge 7a extends in the tire width direction D1, the functioning of edge component(s) at first peripheral edge 7a makes it possible to suppress sliding in the tire circumferential direction D3. Furthermore, because second peripheral edge 7b extends in the tire circumferential direction D3, the functioning of edge component(s) at second peripheral edge 7b makes it possible to suppress sliding in the tire width direction D1.

Further, in the pneumatic tire 1 of the embodiment,

wherein depth of the first block groove 5 decreases as one proceeds toward the interior of the at least one block 3 from a peripheral edge of the at least one block 3.

In accordance with such constitution, because depth of block groove 5 is made to decrease as one proceeds toward the interior from the peripheral edge of block 3, it possible to suppress occurrence of a situation in which rigidity at largest corner 8a becomes too low. As a result, it will be possible to effectively suppress occurrence of variation in rigidity at block 3.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that one 5a of the groove edges at block groove 5 in such fashion as to form straight line (or curve line) together with one of the peripheral edges 7a that make up largest corner 8a. However, pneumatic tire 1 is not limited to such constitution.

As shown in FIG. 5, for example, it is also possible to adopt a constitution in which respective groove edges 5a, 5b at block groove 5 are formed in such fashion as to form bent lines together with respective peripheral edges 7a, 7b that make up largest corner 8a. Respective groove edges 5a, 5b at block groove 5 associated with FIG. 5 intersect respective peripheral edges 7a, 7b making up largest corner 8a in inclined fashion.

(2) Furthermore, the constitution of pneumatic tire 1 associated with the foregoing embodiment is such that one 5a of the groove edges at block groove 5 is formed in such fashion as to form a straight line together with the shorter 7a of first and second peripheral edges 7a, 7b. However, pneumatic tire 1 is not limited to such constitution. For example, it is also possible to adopt a constitution in which one 5b of the groove edges at block groove 5 is formed in such fashion as to form a straight line together with the longer 7b of first and second peripheral edges 7a, 7b.

(3) Furthermore, the constitution of pneumatic tire 1 associated with the foregoing embodiment is such that first peripheral edge 7a which makes up largest corner 8a extends in the tire width direction D1, and second peripheral edge 7b which makes up largest corner 8a extends in the tire circumferential direction D3. However, pneumatic tire 1 is not limited to such constitution. It is also possible to adopt a constitution in which, for example, first and second peripheral edges 7a, 7b which make up largest corner 8a respectively extend in the tire width direction D1; and it is also possible to adopt a constitution in which, for example, these respectively extend in the tire circumferential direction D3.

(4) Furthermore, the constitution of pneumatic tire 1 associated with the foregoing embodiment is such that depth of block groove 5 is made to decrease as one proceeds toward the interior from the peripheral edge of block 3. However, pneumatic tire 1 is not limited to such constitution. For example, it is also possible to adopt a constitution in which depth of block groove 5 is uniform (here understood to mean not only the situation in which this is the same but also situations in which this is approximately the same).

(5) Furthermore, the constitution of pneumatic tire 1 associated with the foregoing embodiment is such that first block 3 is provided with one block groove 5. However, pneumatic tire 1 is not limited to such constitution. For example, it is also possible to adopt a constitution in which first block 3 is provided with a plurality of block grooves 5.

(6) Furthermore, the constitution of pneumatic tire 1 associated with the foregoing embodiment is such that first block 3 having block groove 5 arranged at largest corner 8a thereof is arranged at middle land portion (more specifically, center land portion) 2e. However, pneumatic tire 1 is not limited to such constitution. For example, it is also possible to adopt a constitution in which first block 3 having block groove 5 arranged at largest corner 8a thereof is arranged at shoulder land portion(s) 2d; and it is also possible to adopt a constitution in which, where a plurality of middle land portions 2e are provided, this is arranged at middle land portion(s) 2e other than center land portion 2e.

(7) The constitution of pneumatic tire 1 associated with the foregoing embodiment is such that all first blocks 3 have block grooves 5 arranged at largest corners 8a thereof. However, pneumatic tire 1 is not limited to such constitution. For example, it is also possible to adopt a constitution in which at least one first block 3 among the plurality of first blocks 3 has block groove(s) 5 arranged at largest corner (s) 8a thereof.

Note, for example, that it is preferred that the constitution be such that not less than 25% of the first blocks 3 among the plurality of first blocks 3 have block groove(s) 5 arranged at largest corner(s) 8a thereof. Furthermore, for example, it is more preferred that the constitution be such that not less than 50% of the first blocks 3 among the plurality of first blocks 3 have block groove(s) 5 arranged at largest corner(s) 8a thereof.

(8) Furthermore, there is no particular limitation with respect to the road surface on which pneumatic tire 1 may be used. Pneumatic tire 1 may, for example, be used when driving on snowy road surfaces; or may, for example, be used when driving on adverse road surfaces (e.g., in muddy terrain or rocky terrain); or may, for example, be used when driving on dry road surfaces; or may, for example, be used when driving on wet road surfaces.

1. A pneumatic tire comprising at least one block partitioned by a groove and having a plurality of corners;
wherein the plurality of corners includes a largest corner at which angle is greatest thereamong and is greater than 180°; and
wherein the at least one block comprises a first block groove which is arranged at the largest corner.

2. The pneumatic tire according to claim 1
wherein the at least one block comprises first and second peripheral edges that make up the largest corner;
the first block groove comprises first and second groove edges; and
the first groove edge is formed in such fashion as to form a straight line together with the first peripheral edge.

3. The pneumatic tire according to claim 2
wherein length of the first peripheral edge is less than length of the second peripheral edge.

4. The pneumatic tire according to claim 1
wherein the at least one block comprises first and second peripheral edges that make up the largest corner;
the first peripheral edge extends in a tire width direction in such fashion that angle of inclination thereof with respect to the tire width direction is less than 45°; and
the second peripheral edge extends in a tire circumferential direction in such fashion that angle of inclination thereof with respect to the tire circumferential direction is less than 45°.

5. The pneumatic tire according to claim 1
wherein depth of the first block groove decreases as one proceeds toward the interior of the at least one block from a peripheral edge of the at least one block.

6. The pneumatic tire according to claim 3
wherein the at least one block comprises a plurality of peripheral edges including the first and second peripheral edges; and
length of the first peripheral edge is shortest among the plurality of peripheral edges.

7. The pneumatic tire according to claim 1
wherein the at least one block comprises at least one sipe; and
a first end of the at least one sipe is contiguous with the groove, and a second end of the at least one sipe is located at the interior of the at least one block.

8. The pneumatic tire according to claim 1
wherein width of the first block groove decreases as one proceeds toward the interior of the at least one block from a peripheral edge of the at least one block.

9. The pneumatic tire according to claim 2
wherein length of the first groove edge is less than length of the first peripheral edge.

10. The pneumatic tire according to claim 2
wherein length of the first groove edge is less than length of the second groove edge.
